(19) United States
(12) Patent Application Publication
(10) Pub. No.: US 2018/0074624 A1
(43) Pub. Date: Mar. 15, 2018

(54) Driving Method and Driver Integrated Circuit for Touch Screen

(71) Applicants: BOE Technology Group Co., Ltd., Beijing (CN); Beijing BOE Display Technology Co., Ltd., Beijing (CN)

(72) Inventors: Liang Zhang, Beijing (CN); Baoqiang Wang, Beijing (CN); Peng Jia, Beijing (CN)

(21) Appl. No.: 15/520,538

(22) PCT Filed: May 5, 2016
(86) PCT No.: PCT/CN2016/081086

§ 371 Date: Apr. 20, 2017

(30) Foreign Application Priority Data
Feb. 17, 2016 (CN) 201610090049.X

(51) Int. Cl. G06F 3/047; G06F 3/041

(52) U.S. Cl. CPC G06F 3/047; G06F 3/0412

(57) ABSTRACT

The present disclosure provides a driving method and a driver integrated circuit configured to drive a touch screen using such driving method, for shortening a touch time of the touch screen, thereby prolonging a display time of the touch screen and accordingly improving the charging rate of pixels. The touch screen includes a plurality of touch electrodes arranged in an array and is provided with a time period for displaying a frame, which time period is divided into a touch time period and a display time period. The method includes: dividing the plurality of touch electrodes into at least two groups; and during the touch time period of each frame, scanning each group of touch electrodes with a touch scanning duration which the longest one of durations required for scanning the touch electrodes in the group of touch electrodes.

### CROSS-REFERENCE TO RELATED APPLICATION

This application is a Section 371 National Stage Application of International Application No. PCT/CN2016/081086, filed on May 5, 2016, entitled “Driving Method and Driver Integrated Circuit for Touch Screen”, which has not yet published and which claims priority to Chinese Application No. 201610090049.X, filed on Feb. 17, 2016, incorporated herein by reference in their entirety.

### BACKGROUND

### Technical Field

Embodiments of the present disclosure generally relate to a display technical field, and particularly, to a driving method and a driver integrated circuit for a touch screen.

### Description of the Related Art

With the rapid development of display technology, touch screens (Touch Screen Panel) have gradually spread throughout people's lives. At present, an existing capacitive in-cell touch screen supports a multi-point touch function, has a higher light transmittance and lower overall power consumption, and has a contact surface with high hardness and a longer service life.

In general, a display panel of a touch screen includes a plurality of touch electrodes arranged in an array, and in order to realize a touch function and a display function, the plurality of touch electrodes are configured to receive a touch scanning signal during a touch time period and receive a gate scanning signal during a display time period so as to realize the touch and display functions through the plurality of touch electrodes. Specifically, the touch scanning and the display scanning are shared—time controlled. For example, gate lines connected to several rows of touch electrodes are driven during the display time period, and then when entering the touch time period, a touch scanning signal is sent to several rows of touch electrodes; the display time period is entered again, several rows of gate lines are driven in turn. Display driving and touch scanning are operated cyclically and in turn. A duration required to scan several rows of touch electrodes during the touch time period is one LHB (Long Horizontal Blanking) time.

A manner in which touch electrodes are scanned within the LHB time in the prior art is described as follows:

Referring to FIG. 1, it is assumed that there are 4N rows and M columns of touch electrodes 11 (N and M are each integers greater than or equal to one) in a touch display panel, and each touch electrode is led into a driver integrated circuit (IC) 12 through a routing line (wiring). The first routing line on the left side is the touch line for the touch electrode in the first row and the first column, the second routing line on the left side is the touch line for the touch electrode in the second row and the first column, the third routing line on the left side is the touch line for the touch electrode in the (N+1)th row and the first column, the fourth routing line on the left side is the touch line for the touch electrode in the (2N+1)th row and the first column, the fifth routing line is the touch line for the touch electrode in the (3N+1)th row and the first column, the sixth routing line is the touch line for the touch electrode in the 4Nth row and the first column. The touch lines are arranged sequentially. In the LHB time, the touch scanning starts from the touch electrodes in first row, so that the touch electrodes in the first, the (N+1)th, the (2N+1)th and the (3N+1)th rows are scanned within the first LHB time, and the touch electrodes in the (N+2)th, the (2N+2)th and the (3N +2)th rows are scanned within the second LHB time. All the rows of the touch electrodes are scanned in turn within the touch time period. The touch electrodes scanned within each LHB time are all separated by N rows, thus there are rows of touch electrodes located farther from the driver IC and there are rows of touch electrodes located closer to the driver IC. Due to the RC delay effect, a longer scanning duration is required for the row of touch electrodes located farther from the driver IC. In order to ensure the row of touch electrodes located farthest from the driver IC can be scanned normally, each LHB time is fixed to be the scanning duration required for scanning the row of touch electrodes located farthest from the driver IC in the touch screen.

In view of the above, the touch scanning duration is fixed to be the scanning duration required for scanning the row of touch electrodes located farthest from the driver IC in the touch screen, the touch scanning duration is longer, and the display time of the touch screen is shortened, resulting in the case of insufficient charge of pixels during the display time.

### SUMMARY

Embodiments of the present disclosure provide a driving method and a driver IC of a touch screen, for shortening a touch time required for the touch screen, thereby prolonging a display time of the touch screen and improving charging rate of pixels.

According to an embodiment of the present disclosure, there is provided a driving method for a touch screen, the touch screen comprising a plurality of touch electrodes arranged in an array and provided with a time period for displaying a frame, which time period is divided into a touch time period and a display time period, the method comprising:

dividing the plurality of touch electrodes into at least two groups; and

during the touch time period of each frame, scanning each group of touch electrodes with a touch scanning duration which is the longest one of durations required for scanning the touch electrodes in the group of touch electrodes.

In a possible implementation of the driving method for the touch screen provided by the embodiment of the present disclosure, the touch scanning durations of at least two groups of touch electrodes are different from each other.

In a possible implementation of the driving method for the touch screen provided by the embodiment of the present disclosure, the touch time period of each frame is composed of touch sub-periods interposed between a plurality of the display time periods, and different groups of touch electrodes are scanned within different touch sub-periods.

In a possible implementation of the driving method for the touch screen provided by the embodiments of the present disclosure, each group of touch electrodes comprises at least one row of touch electrodes.

In a possible implementation of the driving method for the touch screen provided by the embodiment of the present disclosure, each group of touch electrodes comprises a plurality of rows of touch electrodes arranged consecutively.

In a possible implementation of the driving method for the touch screen provided by the embodiment of the present disclosure, the numbers of rows of touch electrodes comprised in respective groups of touch electrodes are identical to each other.

In a possible implementation of the driving method for the touch screen provided by the embodiment of the present disclosure, each group of touch electrodes comprises at least one column of touch electrodes.

In a possible implementation of the driving method for the touch screen provided by the embodiment of the present disclosure, each group of touch electrodes comprises a plurality of columns of touch electrodes arranged consecutively.

In a possible implementation of the driving method for the touch screen provided by the embodiment of the present disclosure, the numbers of columns of touch electrodes comprised in respective groups of touch electrodes are identical to each other.

In a possible implementation of the driving method for the touch screen provided by the embodiment of the present disclosure, the touch screen further comprises a signal transmission terminal connected to the touch electrodes by lead wires, and a duration, which is required for scanning the touch electrode, which is connected to the signal transmission terminal with the longest one of respective lead wires, in each group of touch electrodes, is used as the touch scanning duration for the group of touch electrodes.

In a possible implementation of the driving method for the touch screen provided by the embodiment of the present disclosure, the scanning duration required for the touch electrode decreases as a length of the lead wire between the touch electrode and the signal transmission terminal connected thereto decreases.

In a possible implementation of the driving method for the touch screen provided by the embodiment of the present disclosure, the touch screen further comprises a signal transmission terminal connected to the touch electrodes via lead wires, the signal transmission terminal comprising a first signal transmission terminal and a second signal transmission terminal respectively located on upper and lower sides of the touch electrodes arranged in an array, and each group of touch electrodes is scanned within one touch sub-period, and comprises at least two rows of touch electrodes which are connected to the first signal transmission terminal and the second signal transmission terminal by lead wires having a same length.

In a possible implementation of the driving method for the touch screen provided by the embodiment of the present disclosure, the touch screen further comprises a signal transmission terminal connected to the touch electrodes via lead wires, the signal transmission terminal comprising a first signal transmission terminal and a second signal transmission terminal respectively located on left and right sides of the touch electrodes arranged in an array, and each group of touch electrodes is scanned within one touch sub-period and comprises at least two columns of touch electrodes which are connected to the first signal transmission terminal and the second signal transmission terminal by lead wires having a same length.

Accordingly, an embodiment of the present disclosure further provided a driver IC for driving a touch screen by using the above described driving methods provided by the present disclosure.

### BRIEF DESCRIPTION OF THE DRAWINGS

FIG. 1 is a schematic view of an arrangement of touch electrodes of a touch screen provided in the prior art;

FIG. 2 is a flow diagram of a driving method for a touch screen provided by an embodiment of the present disclosure;

FIG. 3 is a schematic diagram illustrating grouping of touch electrodes of a touch screen provided by an embodiment of the present disclosure;

FIG. 4 is a schematic diagram illustrating grouping of touch electrodes of a touch screen provided by another embodiment of the present disclosure;

FIGS. 5a and 5b are schematic views of a driving signal for a touch screen provided by an embodiment of the present disclosure;

FIG. 6 is a schematic diagram illustrating grouping of touch electrodes of a touch panel provided by a further embodiment of the present disclosure; and

FIG. 7 is a schematic diagram illustrating grouping of touch electrodes of a touch screen provided by a still further embodiment of the present disclosure.

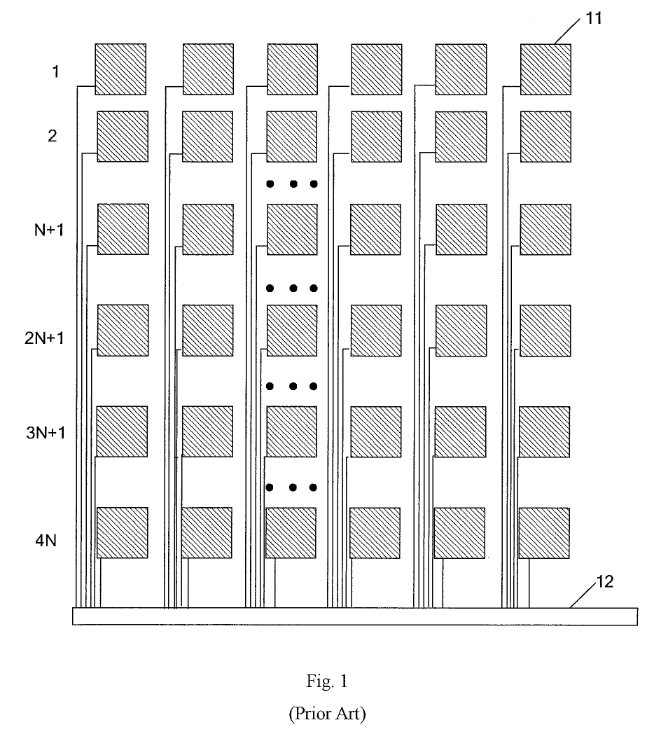

### DETAILED DESCRIPTION OF PREFERRED EMBODIMENTS

For the objects, technical solutions and advantages of the present disclosure being described more clearly, the present disclosure will now be further described specifically with reference to the accompanying drawings. Apparently, the described embodiments are just some, rather than all, of the embodiments of the present disclosure. All other embodiments obtained by those skilled in the art based on the embodiments described in the present disclosure without making creative work fall within the scope of the present disclosure.

Embodiments of the present disclosure provide a driving method of a touch screen and a driver IC configured to drive the touch screen by using such method so as to shorten the touch time for the touch screen, thereby prolonging a display time of the touch screen and improving charging rate of pixels.

Hereinafter, exemplary embodiments of the driving method and the driver IC of a touch screen provided by the embodiments of the present disclosure will be described in detail with reference to the accompanying drawings.

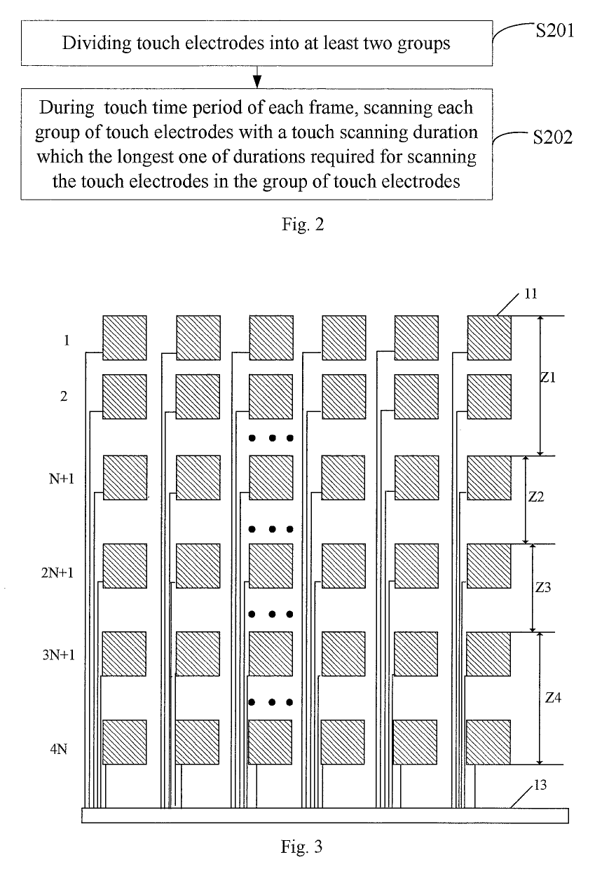

Referring to FIG. 2, a driving method for a touch screen is provided by an embodiment of the present disclosure, the touch screen comprising a plurality of touch electrodes arranged in an array and being provided with a time period for displaying a frame, which time period is divided into a touch time period and a display time period, the method comprising following steps:

Step S201, dividing the plurality of touch electrodes into at least two groups;

Step S202, during the touch time period of each frame, scanning each group of touch electrodes with a touch scanning duration which is the longest one of durations required for scanning the touch electrodes in the group of touch electrodes. As an example, all the touch electrodes in said group of touch electrodes are scanned simultaneously.

In an example, if a plurality of rows of touch electrodes are included in one group of touch electrodes, when scanning each group of touch electrodes during the touch time period for one frame, the plurality of rows of touch electrodes are scanned simultaneously by taking a duration, which is required for the row of touch electrodes that has occupies the longest scanning duration in the group of touch electrodes, as a touch scanning duration for the group of touch electrodes.

In the driving method of the touch screen provided by the embodiments of the present disclosure, the touch electrodes are divided into at least two groups, and during the touch time period of each frame, each group of touch electrodes is scanned by taking a duration, which is the longest duration required for scanning touch electrodes in the group of touch electrodes, as a touch scanning duration for the group of touch electrodes. By using the longest duration required for scanning touch electrodes in each group of touch electrodes as the touch scanning duration for the group of touch electrodes, the touch scanning durations for respective groups of touch electrodes are different from each other, and therefore the touch scanning duration of each group of touch electrodes in the embodiment of the present disclosure is dynamically changed; for example, except the group of touch electrodes having the longest touch scanning duration, each of the other groups of touch electrodes requires a touch scanning duration shorter than the longest touch scanning duration, thereby the touch scanning time for the touch screen is shortened because the touch time for the touch screen is shortened during the one frame time, accordingly the display time of the touch screen is increased and the charging rate of pixels is improved.

Preferably, in the driving method for the touch screen provided by the embodiment of the present disclosure, each group of touch electrodes comprises at least one row of touch electrodes.

Further, when implemented in practice, if the touch electrodes in the touch screen are grouped, a single row of touch electrodes may serve as one group, or a plurality of rows of touch electrodes may serve as a group. Positions of touch electrodes included in each group of touch electrodes are different from each other. Preferably, when scanning each group of touch electrodes, each row of touch electrodes in such group of touch electrodes is scanned simultaneously, thus, in order to save the touch scanning time, it's preferable that each group of touch electrodes comprises a plurality of rows of touch electrodes.

Preferably, in the driving method for the touch screen provided by the embodiments of the present disclosure, each group of touch electrodes comprises a plurality of rows of touch electrodes arranged consecutively or adjacent to each other, or a plurality of rows of touch electrodes arranged at an interval but not located adjacent to each other.

Further, when implemented in practice, if the touch electrodes in the touch panel are grouped, a plurality of rows of touch electrodes which are arranged consecutively or adjacent to each other may serve as a group, or a plurality of rows of touch electrodes which are arranged at an interval but not located adjacent to each other may serve as a group. Embodiments of the present disclosure are not particularly limited in this regard. The positions of the touch electrodes included in each group of touch electrodes are different from each other. The numbers of rows of touch electrodes included in respective groups of touch electrodes may be the same as or different from each other. For example, when each group of touch electrodes comprises a plurality of rows of touch electrodes arranged consecutively, since the distances from the plurality of rows of touch electrodes included in each group of touch electrodes to a signal transmission terminal or the lengths of corresponding lead wires are approximate to each other or differ slightly, durations for scanning respective rows of touch electrodes in such group of touch electrodes are approximate to each other and the touch scanning time is saved.

Preferably, in the driving method for the touch screen provided by the embodiments of the present disclosure, the numbers of rows of touch electrodes comprised in respective groups of touch electrodes are the same.

In an example, the numbers of rows of touch electrodes comprised in respective group of touch electrodes are the same, so that durations for scanning respective groups of touch electrodes are approximate to each other or differ slightly, thus touch scanning duration for the touch electrodes is further shortened.

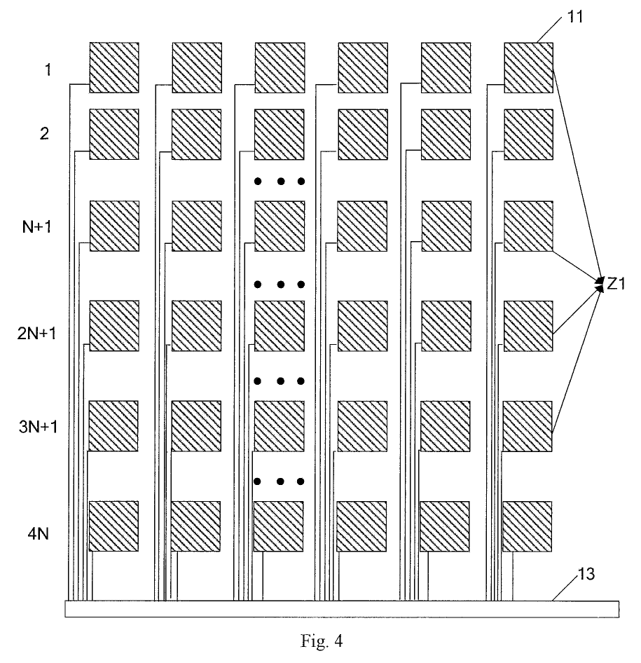

Referring to FIG. 3, it is assumed that there are 4N rows and M columns of touch electrodes 11 (N and M are each integers greater than or equal to one) in the touch screen, and each touch electrode is led to a signal transmission terminal 13 through a routing line or a lead wire. The first routing line on the left side is a touch line for the touch electrode located in the first row and in the first column, the second routing line on the left side is a touch line for the touch electrode located in the second row and in the first column, the third routing line on the left side is a touch line for the touch electrode in located the (N+1)th row and in the first column, the fourth routing line on the left side is a touch line for the touch electrode located in the (2N+1)th row and in the first column, the fifth routing line is a touch line of the touch electrode located in the (3N+1)th row and in the first column 1, the sixth routing line is a touch line for the touch electrode in the 4Nth row and in the first column. The touch lines are arranged sequentially. When the touch electrodes are scanned according to the grouping, the 4N rows and M columns of touch electrodes are divided into four groups to be scanned. The touch electrodes located in the first row to the Nth row may serve as a first group of touch electrodes Z1, the touch electrodes located in the (N+1)th row to the 2Nth row may serve as a second group of touch electrodes Z2, the touch electrodes located in the (2N+1)th row to the 3Nth row may serve as a third group of touch electrodes Z3, and the touch electrodes located in the (3N+1)th row to the 4N row may serve as a fourth group of touch electrodes Z4. When the touch electrodes are scanned, the touch electrodes located in the first row to the Nth row are scanned simultaneously, the touch electrodes located in the (N+1)th row to the 2Nth row are scanned simultaneously, and the third group of the touch electrodes and the fourth group of touch electrodes are scanned in turn. Alternatively, as shown in FIG. 4, the first row, the (N+1)th row, the (2N+1)th row and the (3N+1)th row serve as the first group of touch electrodes Z1, and the second row, the (N+2)th row, the (2N+2)th row and the (3N+2)th row serve as the second group of touch electrodes, and so on, such that the touch electrodes arranged at an interval (for example, arranged at an interval of N rows) are scanned as one group.

Grouping of the touch electrodes is not particularly limited in the embodiment of the present disclosure.

Preferably, in the driving method for the touch screen provided by the embodiments of the present disclosure, the touch scanning durations for at least two groups of touch electrodes are different from each other.

Further, when implemented in practice, if the touch electrodes in the touch screen are grouped, since the touch electrodes are arranged in an array, the distances between respective groups of the touch electrodes and the signal transmission terminal are different from each other, or the lengths of the lead wires leading or connecting respective groups of the touch electrodes to the signal transmission terminal are different from each other. When a touch scanning signal is sent by the signal transmission terminal, the durations required for arriving of the signal to respective group of the touch electrodes are different from each other. In order to ensure respective rows of touch electrodes in each group of touch electrodes can receive the touch scanning signal during the touch time period, the touch scanning duration for each group of touch electrodes is set to be the duration required by a row of touch electrodes which occupies the longest scanning duration in the group of touch electrodes. The positions of the touch electrodes of each group of touch electrode are different from each other, and the RC delays of respective groups of touch electrodes are different from each other, so the touch scanning durations for respective groups of touch electrodes are different from each other. By providing respective groups of touch electrodes with different touch scan durations, for example, the touch scan durations are dynamically distributed or varied according to the distances between respective groups of touch electrodes and the signal transmission terminal or the lengths of the lead wires leading or connecting respective groups of the touch electrodes to the signal transmission terminal. Compared to the solution in the prior art where the scanning duration of the entire touch screen is fixed, the method provided by the present disclosure provides a shorter total touch scanning duration for the entire touch screen, so that the touch time period or duration is shortened within one frame time, the display time period or duration is increased, and the charging rates of pixels are improved.

Preferably, in the driving method for the touch screen provided by the embodiments of the present disclosure, the touch time period of each frame is composed of touch sub-periods interposed between a plurality of display time periods, and different groups of touch electrodes are scanned within different touch sub-periods.

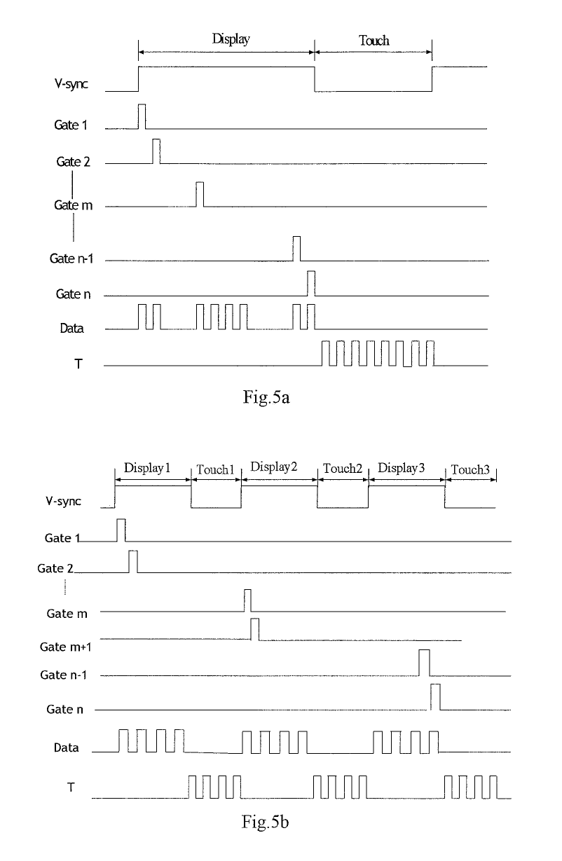

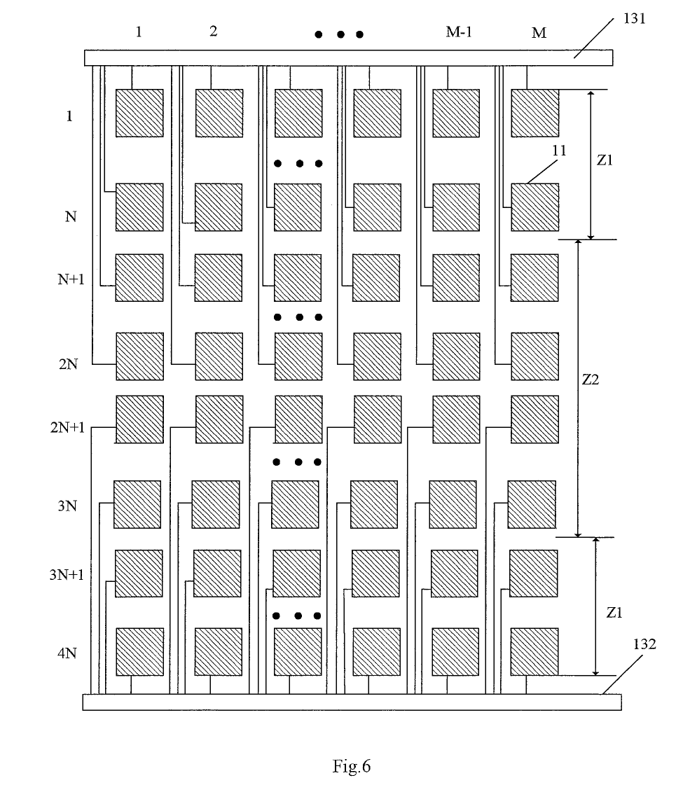

Generally, as shown in FIG. 5a, the time period for displaying each frame (V-sync) of the touch screen may be divided into a display time period (Display) and a touch time period (Touch); for example, in the driving sequence diagram shown in FIG. 5a, the time for displaying each frame of the touch screen is 16.7 ms, with 5 ms therein being selected as the touch time period, and the other 11.7 ms being selected as the display time period. Of course, the durations of the touch time period and the display time period may also be adjusted based on the processing capacity of an IC chip, and will not be particularly limited herein. During the display time period (Display), respective gate signal lines Gate1, Gate2 . . . Gate n connected to the touch electrodes in the touch screen are sequentially applied with a gate scanning signal, the data signal lines Data are applied with a gray signal, achieving a display function of the touch screen. During the touch time period (Touch), respective gate signal lines Gate1, Gate2 . . . Gate n connected to the touch electrodes in the touch screen are sequentially applied with a touch scanning signal T, in order to realize the touch function of the touch screen.

Further, when implemented in practice, when realizing the touch function, touch scanning of the touch screen may be realized within a plurality of touch sub-periods, with the time between the plurality of display time periods being used as the touch sub-periods. For example, in the driving sequence diagram shown in FIG. 5b, a frame time of 16.7 ms is composed of the display time and the touch time, where the display time includes a plurality of display time periods (Display1, Display2, Display3, . . . ), and the touch time includes a plurality of touch sub-periods (Touch1, Touch2, Touch3, . . . ), and each touch sub-period is interposed between two adjacent display time periods. Thus, the touch time periods of each frame may be composed of touch sub-periods interposed between a plurality of display time periods, and the touch electrode groups scanned within respective touch sub-periods are different from each other.

Preferably, in the driving method for the touch screen provided by the embodiments of the present disclosure, the touch scanning duration for each group of touch electrodes is the duration required for scanning the touch electrode with the farthest distance to the signal transmission terminal connected thereto in the group of touch electrodes.

By way of example, the distances between respective groups of touch electrodes to the signal transmission terminal are different from each other. Within each group of touch electrodes, lead wires connecting respective rows of touch electrodes to the signal transmission terminal have different RC delay effect due to the different distances, and thus within each group of touch electrodes, the RC delay time of the farthest row of touch electrodes from the signal transmission terminal is the longest, thus the time required by the farthest row of touch electrodes for receiving the touch scanning signal sent by the signal transmission terminal is the longest, so that the duration required for scanning the touch electrode with the farthest distance to the signal transmission terminal connected thereto in each group of touch electrodes (for example, the touch electrode connected by the longest lead wire to the signal transmission terminal) serves as the touch scanning duration for the group of touch electrodes.

Preferably, in the driving method for the touch screen provided by the embodiments of the present disclosure, the scanning duration required for the touch electrode decreases as the distance between the touch electrode and the signal transmission terminal connected thereto decreases.

Further, when implemented in practice, referring to FIG. 3, in the first group of touch electrodes Z1, as the first row of touch electrodes to the Nth row of touch electrodes are getting closer to the signal transmission terminal 13, RC delay times generated are also getting shorter, thus the scanning durations required are also getting shorter. Further, the scanning duration required for the first row of touch electrodes in the first group of touch electrodes is used as the touch scanning duration for the first group of touch electrodes. Similarly, in the second group of touch electrodes Z2, as the (N+1)th row of touch electrodes to the (2N+1)th row of touch electrodes are getting closer to the signal transmission terminal 13, RC delay times generated are also getting shorter, thus the scanning durations required are also getting shorter. Further, the scanning duration required for the (N+1)th row of touch electrodes in the second group of touch electrodes is used as the touch scanning duration for the second group of touch electrodes. Since the distance from the (N+1)th row of touch electrodes in the second group to the signal transmission terminal 13 is smaller than the distance from the first row of the touch electrodes in the first group of touch electrodes to the signal transmission terminal 13, the touch scanning duration for the second group of touch electrodes is shorter than the touch scanning duration for the first group of touch electrodes.

Preferably, in the driving method for the touch screen provided by the embodiments of the present disclosure, the signal transmission terminal comprises a first signal transmission terminal and a second signal transmission terminal respectively located on upper and lower sides the array of the touch electrodes, and each group of touch electrodes is scanned within one touch sub-period and comprises at least two rows of touch electrodes which have a same distance to the first signal transmission terminal and the second signal transmission terminal respectively.

Preferably, in the driving method for the touch screen provided by the embodiments of the present disclosure, the signal transmission terminal comprises a first signal transmission terminal and a second signal transmission terminal respectively located on left and right sides the array of the touch electrodes, and each group of touch electrodes is scanned within one touch sub-period and comprises at least two columns of touch electrodes which have a same distance to the first signal transmission terminal and the second signal transmission terminal respectively.

Further, when implemented in practice, there may be provided with one or two signal transmission terminals. When there are two signal transmission terminals, the touch electrodes are scanned in groups according to the positions of the signal transmission terminals. The touch electrodes are scanned by means of the first signal transmission terminal and the second signal transmission terminal simultaneously, thereby the touch time is further shortened and the display time is prolonged. In an example, when the first signal transmission terminal and the second signal transmission terminal are located on the upper and lower sides or the left and right sides the array of the touch electrodes, respectively, there are two rows of touch electrodes or two columns of touch electrodes which have a same distance to the first signal transmission terminal and the second signal transmission terminal respectively.

As an example, referring to FIG. 6, it is assumed that there are 4N rows and M columns of touch electrodes 11 (N and M are each integers greater than or equal to one) in the touch screen, and each touch electrode is connected or led to the signal transmission terminal through a routing line. The touch screen comprises a first signal transmission terminal 131 and a second signal transmission terminal 132 respectively located on the upper and lower sides of the touch electrodes 11 arranged in an array. In an example, the touch electrodes of the array located adjacent to the first signal transmission terminal 131 are connected to the first signal transmission terminal 131 and touch electrodes of the array located adjacent to the second signal transmission terminal 132 are connected to the second signal transmission terminal 132, and a plurality of rows of touch electrodes arranged consecutively or at an interval are used as one group of touch electrodes. For example, the first row of touch electrodes to the Nth row of touch electrodes and the (3N+1)th row of touch electrodes to the 4Nth row of touch electrodes serve as a first group of touch electrodes Z1, and the (N+1)th row of touch electrodes to the 2Nth row of touch electrodes and the (2N+1)th row of touch electrodes to the 3Nth row of touch electrodes serve as a second group of touch electrodes Z2. In an example, the first row of touch electrodes to the Nth row of touch electrodes and the (N+1)th row of touch electrodes to the 2Nth row of touch electrodes are connected to the first signal transmission terminal 131, the (2N+1)th row of touch electrodes to the 3Nth row of touch electrodes and the (3N+1)th row of touch electrodes to the 4Nth row of touch electrodes are connected to the second signal transmission terminal 132. During a first touch sub-period when the touch electrodes are scanned, the first signal transmission terminal 131 outputs a scanning signal to the first row of touch electrodes to the Nth row of touch electrodes, while the second signal transmission terminal 132 sends a scanning signal to the touch electrodes in the(3N+1)th row to the 4Nth row. In the first group of touch electrodes, the row of touch electrodes located at the furthest distance from the first signal transmission terminal 131 is the Nth touch electrodes, and the row of touch electrodes located at the furthest distance from the second signal transmission terminal 132 is the (3N+1)th row of touch electrodes. Since the distance between the Nth row of touch electrodes and the first signal transmission terminal 131 is the same as the distance between the (3N+1)th row of touch electrodes and the second signal transmission terminal 132, the touch scanning duration for the first group of touch electrodes is the duration required for scanning the Nth or (3N+1)th row of touch electrodes. Similarly, during the second touch sub-period, the first signal transmission terminal 131 outputs a scanning signal to touch electrodes in the (2N+1)th row to the 3Nth row, while the second signal transmission terminal 132 sends a scanning signal to the touch electrodes in the (3N+1)th row to the 4Nth row. In the second group of touch electrodes, the row of touch electrodes located at the furthest distance from the first signal transmission terminal 131 is the 2Nth row of touch electrodes, and the row of touch electrodes located at the furthest distance from the second signal transmission terminal 132 is the (2N+1) row of touch electrodes. Since the distance between the 2Nth row of touch electrodes and the first signal transmission terminal 131 is the same as the distance between the (2N+1) row of touch electrodes and the second signal transmission terminal 132, the touch scanning duration for the second group of touch electrodes is the duration required for scanning the 2Nth or (2N+1)th row of touch electrodes.

Alternatively, when the touch electrodes are scanned, the second group of touch electrodes may be scanned during the first touch sub-period, and the first group of touch electrodes may be scanned during the second touch sub-period. That is, it is possible to sequentially scan the touch electrodes in an order from far to near from the signal transmission terminal, or to sequentially scan the touch electrodes in order from near to far from the signal transmission terminal.

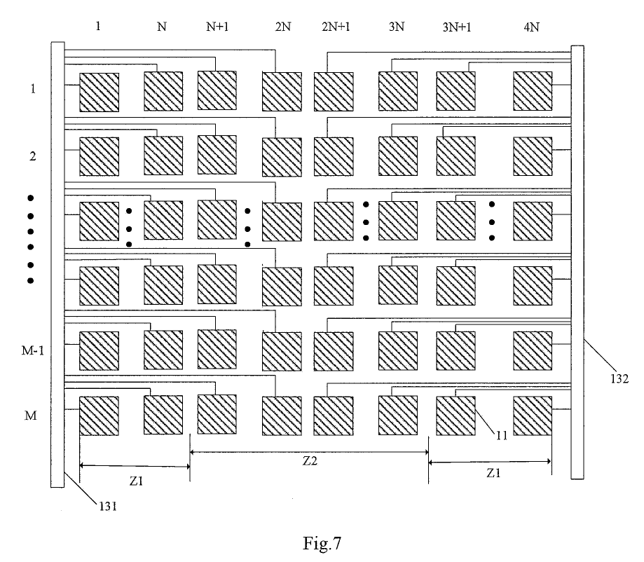

In another embodiment, referring to FIG. 7, it is assumed that there are 4N columns and M rows of touch electrodes 11 (N and M are each integers greater than or equal to one) in the touch screen, and each touch electrode is connected or led to the signal transmission terminal through a routing line. The touch screen comprises a first signal transmission terminal 131 and a second signal transmission terminal 132 respectively located on left and right sides of the touch electrodes arranged in an array. In an example, the touch electrodes of the array located adjacent to the first signal transmission terminal 131 are connected to the first signal transmission terminal 131 and touch electrodes of the array located adjacent to the second signal transmission terminal 132 are connected to the second signal transmission terminal 132, and a plurality of columns of touch electrodes arranged consecutively or at an interval are used as one group of touch electrodes. For example, the first column of touch electrodes to the Nth column of touch electrodes and the (3N+1)th column of touch electrodes to the 4Nth column of touch electrodes serve as a first group of touch electrodes, the (N+1)th column of touch electrodes to the 2Nth column of touch electrodes and the (2N+1)th column of touch electrodes to the 3Nth column of touch electrodes serve as a second group of touch electrodes. In an example, the first column of touch electrodes to the Nth column of touch electrodes and the (N+1)th column of touch electrodes to the 2Nth column of touch electrodes are connected to the first signal transmission terminal 131, the (2N+1)th column of touch electrodes to the 3Nth column of touch electrodes and the (3N+1)th column of touch electrodes to the 4Nth column of touch electrodes are connected to the second signal transmission terminal 132. During a first touch sub-period when the touch electrodes are scanned, the first signal transmission terminal 131 outputs a scanning signal to the first column of touch electrodes to the Nth column of touch electrodes, while the second signal transmission terminal 132 sends a scanning signal to the touch electrodes in the(3N+1)th column to the 4Nth column . In the first group of touch electrodes, the column of touch electrodes located at the furthest distance from the first signal transmission terminal 131 is the Nth column of touch electrodes, and the column of touch electrodes located at the furthest distance from the second signal transmission terminal 132 is the (3N+1)th row of touch electrodes. Since the distance between the Nth column of touch electrodes and the first signal transmission terminal 131 is the same as the distance between the (3N+1)th column of touch electrodes and the second signal transmission terminal 132, the touch scanning duration for the first group of touch electrodes is the duration required for scanning the Nth or (3N+1)th column of touch electrodes. Similarly, during the second touch sub-period, the first signal transmission terminal 131 outputs a scanning signal to touch electrodes in the (2N+1)th column to the 3N column, while the second signal transmission terminal 132 sends a scanning signal to the touch electrodes in the (3N+1)th column to the 4Nth column. In the second group of touch electrodes, the column of touch electrodes located at the furthest distance from the first signal transmission terminal 131 is the 2Nth column of touch electrodes, and the column of touch electrodes located at the furthest distance from the second signal transmission terminal 132 is the (2N+1)th column of touch electrodes. Since the distance between the 2Nth column of touch electrodes and the first signal transmission terminal 131 is the same as the distance between the (2N+1)th column of touch electrodes and the second signal transmission terminal 132, the touch scanning duration for the second group of touch electrodes is the duration required for scanning 2Nth or (2N+1)th column of touch electrodes.

In accordance with the same technical concept, the embodiment of the present disclosure also provides a driver IC for driving a touch screen using any of the driving method for the touch screen provided in the embodiments of the present disclosure. The driving principle of the driver IC is the same as that of the touch driving method provided by the embodiments of the present disclosure, and repetition is not described here.

According to the driving method and the driver IC of the touch screen provided in the embodiments of the present disclosure, the touch electrodes are divided into at least two groups, and during the touch time period of each frame, the longest duration required for scanning touch electrodes in each group of touch electrodes is used as the touch scanning duration for the group of touch electrodes to scan the group of touch electrodes. By using the longest duration required for scanning touch electrodes in each group of touch electrodes as the touch scanning duration for the group of touch electrodes, the scanning durations for respective groups of touch electrodes are different from each other, and therefore the scanning duration of each group of touch electrodes during the touch time in the embodiments of the present disclosure is dynamically changed, thereby the touch scanning time of the touch screen is shortened because the touch time of the touch screen is shortened within the one frame time, accordingly the display time of the touch screen is increased and the charging rate of pixels is improved.

It will be apparent to those skilled in the art that various changes and modifications may be made to the present disclosure without departing from the spirit and scope of the disclosure. In this way, the present disclosure is intended to embrace such modifications and variations if the modifications and variations of this disclosure are within the scope of the appended claims and the equivalents thereof.

1. A driving method for a touch screen, the touch screen comprising a plurality of touch electrodes arranged in an array and provided with a time period for displaying a frame, which time period is divided into a touch time period and a display time period, the method comprising:
dividing the plurality of touch electrodes into at least two groups; and
during the touch time period of each frame, scanning each group of touch electrodes with a touch scanning duration which is the longest one of durations required for scanning the touch electrodes in the group of touch electrodes.

2. The method according to claim 1, wherein the touch scanning durations of at least two groups of touch electrodes are different from each other.

3. The method according to claim 1, wherein the touch time period of each frame is composed of touch sub-periods interposed between a plurality of the display time periods, and different groups of touch electrodes are scanned within different touch sub-periods.

4. The method according to claim 1, wherein each group of touch electrodes comprises at least one row of touch electrodes.

5. The method according to claim 4, wherein each group of touch electrodes comprises a plurality of rows of touch electrodes arranged consecutively.

6. The method according to claim 5, wherein the numbers of rows of touch electrodes comprised in respective groups of touch electrodes are identical to each other.

7. The method according to claim 1, wherein each group of touch electrodes comprises at least one column of touch electrodes.

8. The method according to claim 7, wherein each group of touch electrodes comprises a plurality of columns of touch electrodes arranged consecutively.

9. The method according to claim 8, wherein the numbers of columns of touch electrodes comprised in respective groups of touch electrodes are identical to each other.

10. The method according to claim 1, wherein the touch screen further comprises a signal transmission terminal connected to the touch electrodes by lead wires, and wherein a duration, which is required for scanning the touch electrode, which is connected to the signal transmission terminal with the longest one of respective lead wires, in each group of touch electrodes, is used as the touch scanning duration for the group of touch electrodes.

11. The method according to claim 10, wherein the scanning duration required for the touch electrode decreases as a length of the lead wire between the touch electrode and the signal transmission terminal connected thereto decreases.

12. The method according to claim 3, wherein the touch screen further comprises a signal transmission terminal connected to the touch electrodes via lead wires, the signal transmission terminal comprising a first signal transmission terminal and a second signal transmission terminal respectively located on upper and lower sides of the touch electrodes arranged in an array, and
wherein each group of touch electrodes is scanned within one touch sub-period, and comprises at least two rows of touch electrodes which are connected to the first signal transmission terminal and the second signal transmission terminal by lead wires having a same length.

13. The method according to claim 3, wherein the touch screen further comprises a signal transmission terminal connected to the touch electrodes via lead wires, the signal transmission terminal comprising a first signal transmission terminal and a second signal transmission terminal respectively located on left and right sides of the touch electrodes arranged in an array, and
wherein each group of touch electrodes is scanned within one touch sub-period and comprises at least two columns of touch electrodes which are connected to the first signal transmission terminal and the second signal transmission terminal by lead wires having a same length.

14. A driver integrated circuit configured to drive a touch screen by using the driving method of claim 1.

15. The method according to claim 2, wherein each group of touch electrodes comprises a plurality of rows of touch electrodes arranged consecutively.

16. The method according to claim 2, wherein each group of touch electrodes comprises a plurality of columns of touch electrodes arranged consecutively.

17. The method according to claim 2, wherein the touch screen further comprises a signal transmission terminal connected to the touch electrodes by lead wires, and wherein a duration, which is required for scanning the touch electrode, which is connected to the signal transmission terminal with the longest one of respective lead wires, in each group of touch electrodes, is used as the touch scanning duration for the group of touch electrodes.

18. The method according to claim 3, wherein the touch screen further comprises a signal transmission terminal connected to the touch electrodes by lead wires, and wherein a duration, which is required for scanning the touch electrode, which is connected to the signal transmission terminal with the longest one of respective lead wires, in each group of touch electrodes, is used as the touch scanning duration for the group of touch electrodes.

19. The method according to claim 5, wherein the touch screen further comprises a signal transmission terminal connected to the touch electrodes by lead wires, and wherein a duration, which is required for scanning the touch electrode, which is connected to the signal transmission terminal with the longest one of respective lead wires, in each group of touch electrodes, is used as the touch scanning duration for the group of touch electrodes.

20. The method according to claim 17, wherein the scanning duration required for the touch electrode decreases as a length of the lead wire between the touch electrode and the signal transmission terminal connected thereto decreases.
